(19) United States
(12) Patent Application Publication
(10) Pub. No.: US 2003/0162117 A1
(43) Pub. Date: Aug. 28, 2003

(54) Developing agent and method for manufacturing the same

(75) Inventor: Akira Kambayashi, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/084,504

(22) Filed: Feb. 28, 2002

(51) Int. Cl. G03G 9/093

(52) U.S. Cl. 430/110.2; 430/137.11

(57) ABSTRACT

A multi-layered toner includes a resin covering layer formed by a dry process on a toner core.

### BACKGROUND OF THE INVENTION

The present invention relates to a developing agent used in an image forming apparatus of an electrostatic recording system and an electrophotographic system and a method of manufacturing the same, particularly, to a developing agent having a multi-layered structure and a method of manufacturing the same.

In the conventional manufacturing method of a developing agent by the pulverizing method, a toner was obtained by the process including the step of mixing, for example, a coloring agent, a charge control agent, a wax and an additive with a binder resin, followed by melting and kneading the mixture, the step of drying and pulverizing the kneaded mixture, followed by classifying the pulverized mixture so as to obtain toner particles having a desired particle diameter, and the step of adding another additive to the surface of the resultant toner particle so as to obtain a desired toner.

On the other hand, in the conventional manufacturing method of a developing agent by the polymerization method, a toner was obtained by the process including the step of performing a polymerizing reaction while dispersing, for example, a coloring agent, a charge control agent, a wax and an additive in a binder resin material such as a monomer and a low molecular weight polymer thereof so as to prepare toner particles having a desired particle diameter by controlling the polymerizing conditions, and the step of adding another additive to the surface of the resultant toner particles so as to obtain a desired toner. The toner manufactured by the polymerization method is advantageous over the toner manufactured by the pulverizing method in that it is possible to obtain particles relatively uniform in diameter and shape. However, the toner manufactured by the polymerization method is disadvantageous in that the manufacturing cost is high and the cleaning properties are poor.

The fixing characteristics and the resistance to blocking of the developing agent, which were contradictory to each other, were dependent mainly on the thermal characteristics of the binder resin. Therefore, it was very difficult in the past to satisfy simultaneously both the fixing characteristics and the resistance to blocking of the developing agent.

A measure for overcoming the above-noted difficulty is proposed in, for example, Jpn. Pat. Appln. KOKAI Publication No. 11-174732. Specifically, proposed in this prior art is a multi-layered toner prepared by forming the core of a toner by a polymerization method, followed by forming an outer layer called a shell on the outer surface of the core by polymerization by using a binder resin material differing in the glass transition point from the binder resin contained in the core. The multi-layered toner of this type, which is called a capsule toner, is advantageous in that the capsule toner is enabled to satisfy both the fixing characteristics and the resistance to the blocking by controlling the thermal characteristics of the binder resin used in each of the core and the shell. However, the capsule toner gives rise to the problem that, for example, the manufacturing cost is high.

### BRIEF SUMMARY OF THE INVENTION

An object of the present invention, which has been achieved in view of the situation described above, is to provide a developing agent satisfactory in both the fixing characteristics and the resistance to the blocking and capable of being manufactured at a low cost.

Another object of the present invention is to provide a method of manufacturing a developing agent satisfactory in both the fixing characteristics and the resistance to the blocking and capable of being manufactured at a low cost.

According to a first aspect of the present invention, there is provided a developing agent comprising multi-layered toner particles each including a toner core containing a coloring agent and a binder resin, and a resin covering layer formed by a dry process to cover the toner core.

According to a second aspect of the present invention, there is provided a method for manufacturing a developing agent, comprising obtaining multi-layered toner particles by forming a resin covering layer by a dry process to cover a toner core containing a coloring agent and a binder resin.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a model drawing for explaining as an example the construction of the toner of the present invention;

FIG. 2 is a conceptual view for explaining the principle of the mechanofusion treatment;

FIG. 3 is a schematic view showing an example of an apparatus used for the hybridization treatment;

FIG. 4 is a schematic view for explaining a surfusing system;

FIG. 5 is a flow chart showing an example of a method of manufacturing the toner of the present invention;

FIG. 6 is a flow chart showing another example of a method of manufacturing the toner of the present invention; and

FIG. 7 shows an example of an image forming apparatus that is used preferably in the present invention.

### DETAILED DESCRIPTION OF THE INVENTION

According to a first aspect of the present invention, there is provided a developing agent comprising a multi-layered toner having a resin covering layer formed by a dry process on a toner core containing a coloring agent and a binder resin.

According to a second aspect of the present invention, there is provided a method of manufacturing the developing agent referred to above, comprising forming a multi-layered toner having a resin covering layer formed by a dry process on a toner core containing a coloring agent and a binder resin so as to obtain multi-layered toner particles.

The toner core used in the present invention contains a coloring agent and a binder resin. It is possible to disperse the coloring agent into the toner core. Alternatively, it is possible to attach a coloring agent to the surface of the core body containing a binder resin as a main component, or to have the surface of the core body covered with the coloring agent.

It is possible for the toner core to contain appropriately a wax, a charge control agent and other additives.

The other additives noted above include, for example, a lubricant, a cleaning assistant and a fluidizing agent.

It is possible to attach, as required, additives such as silica, titania and alumina particles to the surfaces of the multi-layered toner particles.

It is also possible to prepare a two-component developing agent by mixing the multi-layered toner particles with the carrier.

Further, the resin covering layer contains at least a binder resin.

It is possible for the binder resin contained in the resin covering layer to be equal to or different from the binder resin contained in the toner core. In order to obtain a sufficient strength of the toner, it is desirable to select resins compatible with each other.

It is possible to add, as required, a wax, a coloring agent, a lubricant, a cleaning assistant, a fluidizing agent, etc. to the resin covering layer.

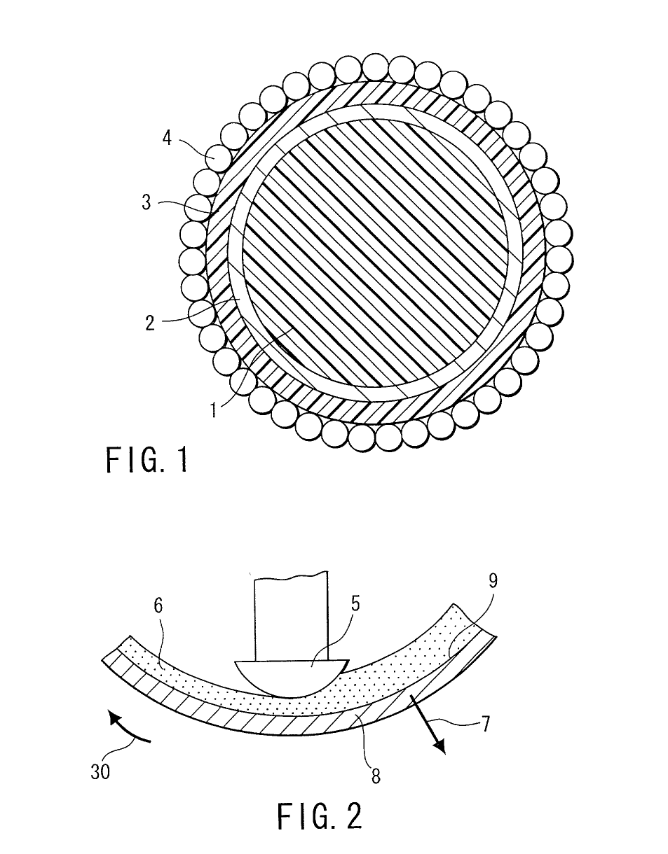

An example of the construction of the toner of the present invention will now be described with reference to FIG. 1.

As shown in the drawing, the toner of the present invention comprises a toner core body 1, a coloring agent layer 2 formed on the toner core body 1, a resin covering layer 3 formed by a dry process in a manner to cover the surface of the coloring agent layer 2, and additive particles 4 attached to the surface of the resin covering layer 3.

The dry process employed in the present invention represents a process for covering the surface of the toner core with a material containing a resin as a main component. The dry process includes the process other than the polymerization processes performed within a liquid such as a solution polymerization process, a suspension polymerization process and an emulsion polymerization process.

Since the properties of the resin are changed depending on the manufacturing process even if the same kind of resin material is used for forming the covering layer, the covering layer formed by the dry process can be clearly distinguished from the covering layer formed by the polymerization process.

The dry process employed in the present invention includes, for example, a mechanical process, a thermal process, a mechanochemical process and a process involving at least two of these processes.

Since the toner included in the developing agent of the present invention is of a multi-layered structure, it is possible to separate the function of the toner core from the function of the resin covering layer. For example, it is possible to use a composition having an emphasis placed on the fixing properties for forming the toner core and a composition having an emphasis placed on the storage properties under high temperatures for forming the resin covering layer. As a result, it is possible to satisfy the combination of the mutually contradictive characteristics of the developing agent that were difficult to satisfy in the toner of a single layer structure. For example, it is possible to satisfy simultaneously both the fixing properties and the storage properties under high temperatures.

It should also be noted that, according to the present invention, it is possible to form the resin covering layer by the dry process such as a chemical process, a thermal process or a mechanochemical process in place of the costly polymerization process carried out within a liquid such as a solution polymerization method, a suspension polymerization method or an emulsion polymerization process, with the result that it is possible to manufacture the toner having a multi-layered structure easily and at a low manufacturing cost. Further, the additive such as a charge control agent can be applied easily to the resin covering layer.

The resin covering layer can be formed by performing the dry process only once by using a single resin covering material. It is also possible to form the resin covering layer by a plurality of dry processes by using a single resin covering material and changing, for example, the kinds and the conditions of the dry processes. Further, it is possible to form the resin covering layer such that the toner core is covered with an optional resin covering materials by a plurality of dry processes using a plurality of resin covering materials. It should also be noted that the additives that can be applied to the surface of the toner particle such as a cleaning assistant and a fluidizing agent can be attached easily to the resin covering layer after the dry process.

Incidentally, powdery resin materials such as particles of a single resin, resin composition particles and particles having a toner composition can be suitably used as the resin covering material in the dry process.

The dry process that can be employed in the present invention includes, for example, a mechanofusion process, a hybridization process and a surfusing process.

FIG. 2 conceptually shows the principle of the mechanofusion process. The mechanofusion process is one of the mechanochemical processes. In the mechanofusion process, an ordered mixture, which is prepared by subjecting a powdery material containing, for example, mother particles and child particles to a dry mixing so as to permit the child particles to be attached to the mother particles, is put as a powdery raw material 6 in a rotary container 8 rotating in a direction denoted by, for example, an arrow 30. Within the rotary container 8, the powdery raw material 6 is pushed against and fixed to the inner wall 9 of the rotary container 8 by the centrifugal force acting in the direction denoted by an arrow 7. In addition, an inner piece 5 differing from the inner wall 9 in the radius of curvature is applied to the fixed powdery material 6 so as to impart a more stronger compression and shearing force to the fixed powdery raw material 6, thereby preparing composite particles, controlling the shape of the particles and achieving a precision mixing.

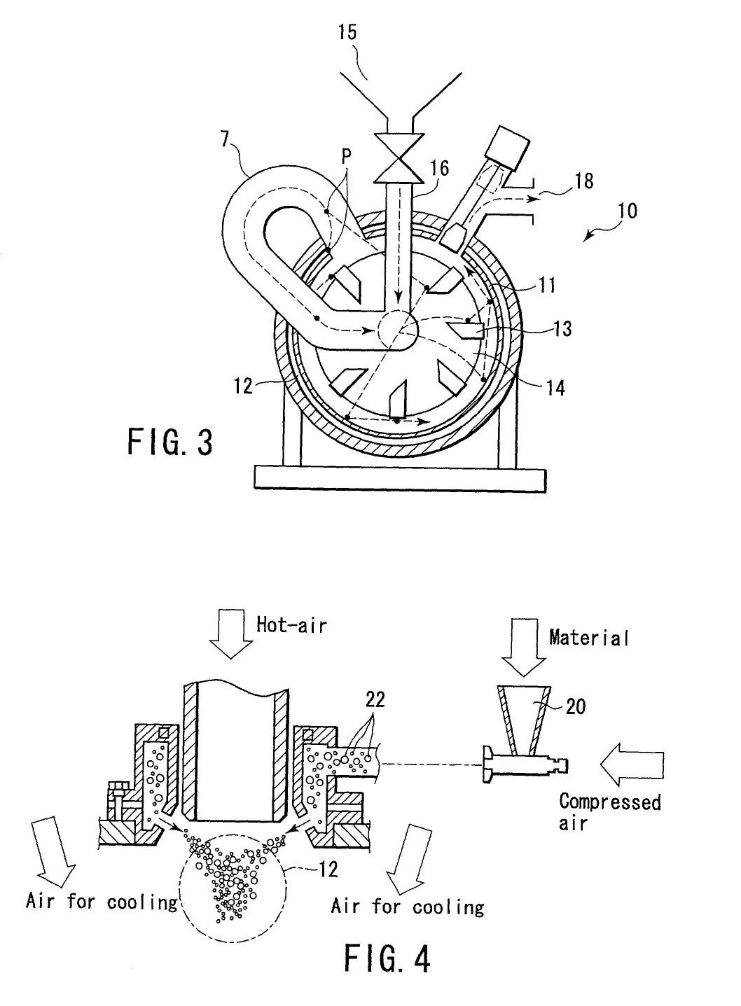

FIG. 3 schematically shows as an example an apparatus used in the hybridization process. The hybridization process is one the mechanical and thermal processes. Used in the hybridization process is, for example, an apparatus 10 shown in the drawing. The apparatus 10 comprises a cylindrical stator 11 provided with a jacket 12 for the water cooling and for heating, a rotor 14 provided with a plurality of blades 13 and capable of a high speed rotation, an input port 15 for introducing a powdery material into the stator 11, a transfer path 16 for transferring the powdery raw material to the central portion of the rotor 14, a circulating path 17 for transferring again the powdery material from the inner wall of the stator 11 to the central portion of the rotor 14, and a discharge port 18 for discharging the processed powdery material.

As shown in the drawing, a powdery raw material, e.g., an ordered mixture, is put into the apparatus 10 through the inlet port 15 so as to be dispersed onto the inner surfaces of the rotor 14 rotating at a high speed and the stator 11. Further, the powdery raw material is circulated again from the inner surface of the stator 11 into the central portion of the rotor 14 through the circulating path 17. In this case, mechanical functions such as the impact force including the mutual function among the particles, compression, friction and shearing force are repeatedly applied to the powdery raw material so as to permit the child particles to fix the mother particles, to form a film, and to make the particles spherical. The processed powdery material is discharged to the outside through the discharge port 18 so as to be recovered promptly in a collector (not shown). Incidentally, the letter P shown in the drawing denotes the powdery material, and the arrow of the broken line denotes the behavior of the powdery material P.

FIG. 4 schematically shows a surfusing system. The surfusing system is one of thermal processes. In the surfusing system, a powdery raw material 22, e.g., an ordered mixture, put through an inlet port 20 is dispersed into a hot air stream within a process section 21 by a special method using a compressed air, as shown in the drawing, so as to heat the powdery raw material 22 to temperatures not lower than the temperature at which the powdery raw material 22 begins to be melted. As a result, the powdery material is made spherical and the child particles are fixed to the mother particles. Where resin fine particles constitute the child particles, it is possible to permit the child particles to be attached to the mother particles so as to form a film.

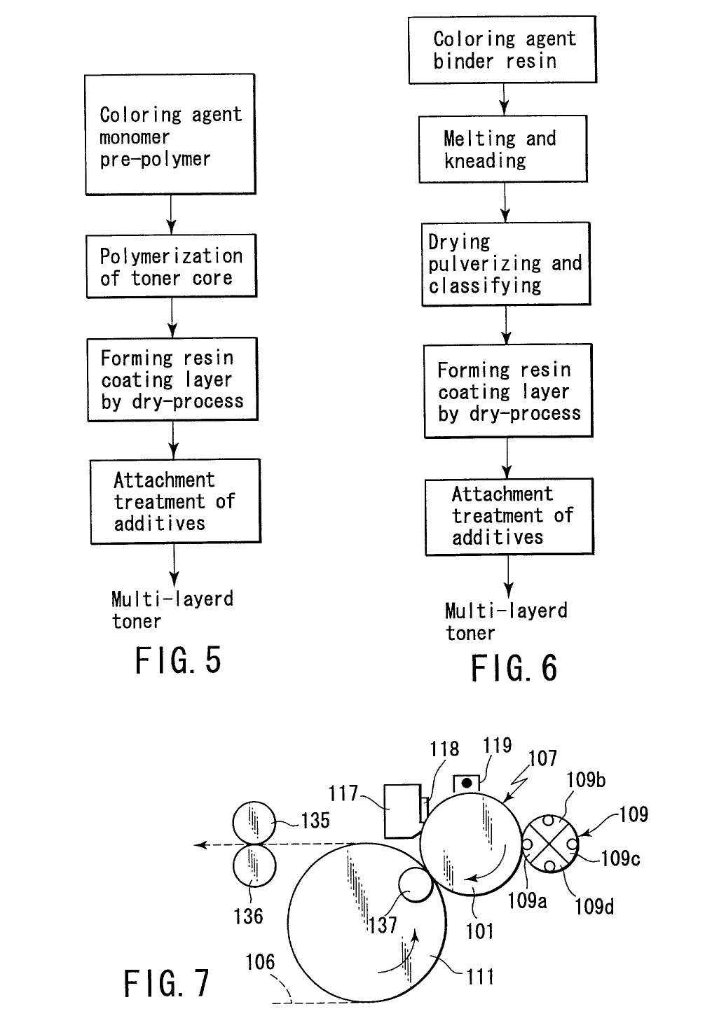

The toner core used in the present invention can be prepared by any of the pulverizing method and the polymerization method. FIG. 5 is a flow chart showing as an example a method of manufacturing the toner of the present invention, covering the case where the toner core is formed by the polymerization method.

As shown in the drawing, the toner manufacturing method comprises polymerizing the toner core containing a coloring agent as well as a monomer and a prepolymer of the binder resin so as to obtain the toner core; forming a resin covering layer on the surface of the toner core thus obtained by a dry process so as to obtain a multi-layered toner particles, and attaching an optional additive to the multi-layered toner particle.

A modification of the manufacturing method described above comprises the step of polymerizing a polymer material of the toner core that does not contain a coloring agent so as to obtain a toner core body, the step of attaching a coloring agent to the surface of the toner core so as to form a toner core, the step of forming a resin covering layer by a dry process on the surface of the toner core so as to obtain a multi-layered toner particle, and the step of attaching an optional additive to the multi-layered toner particles.

The toner core prepared by the polymerization method is relatively small in the nonuniformity of the particle diameter. Therefore, it is possible to obtain toner particles uniform in diameter and shape.

FIG. 6 is a flow chart showing as an example the method of manufacturing the toner of the present invention, covering the case where the toner core is formed by the pulverizing method. As apparent from the drawing, the method shown in FIG. 6 comprises; melting and kneading a toner core material containing, for example, a coloring agent and a binder resin; drying and pulverizing the kneaded mass, followed by classifying the pulverized material so as to form a toner core; forming a resin covering layer by a dry process on the surface of the toner core so as to obtain a multi-layered toner particle, and the step of attaching an optional additive to the surface of the multi-layered toner particle.

A modification of the manufacturing method shown in FIG. 6 comprises; melting and kneading a toner core material that does not contain a coloring agent; drying and pulverizing the kneaded mass; followed by classifying the pulverized material so as to form a toner core body; attaching a coloring agent to the surface of the toner core body so as to form a toner core; forming a resin covering layer by a dry process on the surface of the toner core thus formed so as to obtain a multi-layered toner particle, and attaching an optional additive to the surface of the multi-layered toner particle.

The toner core prepared by the pulverizing process is somewhat nonuniform in the particle diameter and has a random shape. However, an impact is imparted to the toner core by the dry process in the step of forming the resin covering layer, with the result that the resultant multi-layered toner particle is rendered spherical. Also, the irregularly-shaped toner particles are advantageous over the spherical toner particles having a uniform particle diameter in that the toner particles are unlikely to pass through, for example, a cleaning blade in an image forming apparatus equipped with a cleaning apparatus using the cleaning blade, with the result that it is possible to expect an improvement in the cleaning function.

It is also possible to subject the toner core to a dry process in advance, with the result that the toner core surface is modified so as to form a stronger surface layer. It is possible to employ preferably a surfusing process as the dry process.

FIG. 7 shows as an example the construction of an image forming apparatus used preferably in the present invention. As shown in the drawing, the image forming apparatus comprises a photoreceptor drum 101 acting as an image carrier. The photoreceptor drum 101 is formed of a cylindrical lamination type organic photoreceptor having a diameter of, for example, 40 mm and a length of, for example, 266 mm and is arranged rotatable in a direction denoted by an arrow.

Various devices are arranged around the photoreceptor drum 101.

Specifically, a developing device 109 housing a developing agent and serving to develop an electrostatic latent image formed by a light exposure section 107 with the developing agent is arranged to face the photoreceptor drum 101. A roller-like transfer means 111, which serves to bring a paper sheet used as a recording material into contact with the photoreceptor drum 101 for transferring a developing agent image formed on the surface of the photoreceptor drum 101 onto the paper sheet, is arranged downstream of the developing device 109 in the rotating direction of the photoreceptor drum 101. The transfer means 111 is arranged rotatable in synchronism with the rotation of the photoreceptor drum 101. A blade cleaning device 117 equipped with a cleaning blade 118 and a destaticizing lamp 119 are arranged downstream of the transfer means 111 in the rotating direction of the photoreceptor drum 101. The cleaning blade 118 included in the blade cleaning device 117 serves to scratch off the developing agent remaining on the photoreceptor drum 101 after transfer of the developing agent image onto the paper sheet so as to remove the residual developing agent. On the other hand, the destaticizing lamp 119 is formed of a tungsten lamp serving to destaticize the surface of the photoreceptor drum 101 after transfer of the developing agent image onto the paper sheet. One cycle of the image forming operation is finished by the destaticization performed by the destaticizing lamp 119. When a new image is formed on the surface of the photoreceptor drum 101, the uncharged surface of the photoreceptor drum 101 is charged again.

A paper feeding cassette (not shown) housing paper sheets is arranged in the vicinity of the transfer means 111. A paper sheet is transferred from the paper feeding cassette in the direction denoted by an arrow 107 so as to be fed between the photoreceptor drum 101 and the transfer means 111.

As shown in the drawing, the developing device 109 is partitioned into four sections consisting of a first developing section 109a, a second developing section 109b, a third developing section 109c and a fourth developing section 109d. The developing device 109 is arranged rotatable such that the first developing section 109a, the second developing section 109b, the third developing section 109c and the fourth developing section 109d are successively allowed to face the surface of the photoreceptor drum 101 in the order mentioned. The developing agents of the present invention having different colors are housed in the developing sections 109a, 109b, 109c and 109d, respectively. For example, a yellow developing agent is housed in the first developing section 109a, a magenta developing agent is housed in the second developing section 109b, a cyan developing agent is housed in the third developing section 109c, and a black developing agent is housed in the fourth developing section 109d.

The image forming apparatus of the particular construction is operated as follows for forming an image. In the first step, a bias voltage is applied to the surface of the photoreceptor drum 101 by a charging means (not shown) so as to charge uniformly the surface of the photoreceptor drum 101. Then, a first electrostatic latent image is formed on the surface of the photoreceptor drum 101 by means of light irradiation 107. Further, the first developing section 109a of the developing device 109 is positioned to face the electrostatic latent image formed on the surface of the photoreceptor drum 101 so as to supply the first developing agent to the electrostatic latent image, thereby forming a first developing agent image on the surface of the photoreceptor drum 101.

If a paper sheet is transferred to the transfer position, a bias voltage is applied from a power feeding means 137 to the transfer means 111, with the result that a transfer electric field is formed between the photoreceptor drum 101 and the transfer means 111. It follows that the yellow developing agent image formed on the photoreceptor drum 101 is transferred onto the paper sheet.

After transfer of the developing agent image, the first developing agent and the charge remaining on the photoreceptor drum 101 are removed by the cleaning device 117 and the destaticizing means 119, respectively.

In the next step, a second electrostatic latent image is formed by means of light irradiation 107 on the surface of the photoreceptor drum 101 having the residual yellow developing agent and the residual charge removed therefrom. When the developing device 109 makes one-fourth of one complete rotation, the second developing section 109b is positioned to face the second electrostatic latent image formed on the surface of the photoreceptor drum 101. Under this particular state, the magenta developing agent is supplied to the second electrostatic latent image so as to form a magenta developing agent image on the surface of the photoreceptor drum 101. Then, a bias voltage is applied again from the power feeding means 137 to the transfer means 111, with the result that a transfer electric field is formed between the photoreceptor drum 101 and the transfer means 111. It follows that the magenta developing agent image formed on the surface of the photoreceptor drum 101 is further transferred onto the paper sheet having the yellow developing agent image transferred thereonto in advance.

Further, a cyan developing agent image and a black developing agent image are successively transferred onto the paper sheet by repeating the steps described above so as to form a laminated structure of the yellow, magenta, cyan and black developing agent images.

The paper sheet P bearing the image formed by the multiple transfer of the developing agent images described above is transferred in the direction denoted by the arrow 106 so as to be supplied to a fixing device comprising a heating roller 135 and a pressurizing roller 137. The paper sheet P is passed through the clearance between the heating roller 135 and the pressurizing roller 137 such that the developing agent image formed on the paper sheet is brought into contact with the heating roller 135, with the result that the developing agent image is fixed to the paper sheet P. The fixed image thus formed was found to be satisfactory.

The apparatus described above is no more than an example of the image forming apparatus to which the developing agent of the present invention can be applied. In other words, it is also possible to apply the developing agent of the present invention to a full color image forming apparatus and a monochromatic image forming apparatus having another construction.

The binder resin that can be used in the present invention includes, for example, a polyester resin, polystyrene resin, styrene-acrylate copolymer resin, polyester-styrene acrylate hybrid resin, epoxy resin and polyether-polyol resin.

The wax that can be used in the present invention includes, for example, natural waxes such as rice wax and carnauba wax; petroleum waxes such as paraffin wax; and synthetic waxes such as fatty acid ester, fatty acid amide, low molecular weight polyethylene, and low molecular weight polypropylene.

Further, the coloring agent that can be used in the present invention includes, for example, carbon black, and organic or inorganic pigment and dye. The carbon black that can be used in the present invention includes, for example, acetylene black, furnace black, thermal black, channel black and Ketchen black, though the carbon black used in the present invention is not particularly limited. Further, the pigment and dye that can be used in the present invention includes, for example, pigment yellow 180, fast yellow G, benzidine yellow, indofast orange, irgazine red, carmine FB, carmine 6B, permanent Bordeaux FRR, pigment orange R, pigment red 122, lithol red 2G, lake red C, rhodamine FB, rhodamine B lake, phthalocyanine blue, pigment blue 15-3, brilliant green B, phthalocyanine green, and quinacridone. These pigments and dyes can be used singly or in the form of a mixture of at least at least two of these materials.

The present invention will now be described more in detail with reference to Examples of the present invention.

### EXAMPLES

### Example 1

A tone core body was prepared by melting and kneading a polyester resin having a glass transition point of 60° C., which was used as a toner core material, followed by drying and pulverizing the kneaded material and subsequently classifying the pulverized material.

Added to 70 parts by weight of the toner core body thus obtained were 5 parts by weight of a copper phthalocyanine series cyan pigment, 4 parts by weight of polypropylene wax and 1 part by weight of a colorless metal complex CCA. The resultant mixture was subjected to a mechanofusion treatment for 3 to 60 minutes by using a mechanofusion system AMS-1 manufactured by Hosokawa Micron Inc. so as to cover the toner core body with an intermediate layer containing the coloring agent, thereby obtaining a toner core.

Then, an ordered mixture was prepared by dry mixing 20 parts by weight of acryl fine particles having a glass transition point of 55° C. and an average particle diameter of 150 nm, which were used as a covering layer material, with 80 parts by weight of the toner core thus prepared. A mechanofusion treatment was applied to the ordered mixture thus obtained, followed by subjecting the processed powder to a surfusing treatment by using a surfusing system SFS-1 type manufactured by Japan Pneumatic Industries K.K. at a supply rate of 0.5 to 2 kg/hour and under a processing temperature of 250 to 450° C. so as to cover the toner core with the acrylic resin, thereby obtaining multi-layered toner particles having an average particle diameter of 8.5 μm.

Further, a toner was obtained by mixing 1.0 part by weight of silica particles with 100 parts by weight of the multi-layered particles thus obtained by using a Henschel mixer.

In order to look into the storage properties of the resultant toner under high temperatures, 20 g of the toner was left to stand under an environment having a temperature of 30° C. and a humidity of 85% as a test for examining the resistance to the blocking. The blocking resistance was evaluated as “poor” and “good” by visually confirming the presence or absence of the cohesion lump in the obtained toner.

Also, a developing agent was prepared by mixing 94 parts by weight of a ferrite carrier with 6 parts by weight of the obtained toner.

The developing agent thus obtained was set in a printing machine “Premarju 455” manufactured by Toshiba Tec K.K., which was modified for use for evaluation. After the fixing temperature was set at 140° C., printing was actually performed by using the printing machine.

For determining the fixation remaining rate of the image thus obtained, the image density before rubbing of the image with a fastness tester and the image density after the rubbing were measured so as to obtain a ratio of the image density before the rubbing to the image density after the rubbing. The image having a fixation remaining rate not lower than 80% was evaluated as a good image having a sufficient image strength. The image having a fixation remaining rate of 70 to 79% was evaluated as an image that does not give rise to a practical problem. Further, the image having a fixation remaining rate not higher than 69% was evaluated as a poor image low in the image strength.

Further, the sum of the manufacturing cost of the dry capsule toner required in the process ranging between the manufacture of the core material and the final processing was compared with the manufacturing cost of the conventional pulverized toner required in the steps of the kneading, pulverization, classification and the additive attaching treatment for evaluating the manufacturing cost of the toner.

Table 1 shows the results of evaluation of the fixation remaining rate, the blocking resistance and the manufacturing cost.

As shown in Table 1, the fixation remaining rate was found to be 85%. The blocking resistance was found to be satisfactory (cohesion lump was not recognized). Further, the manufacturing cost was low.

### Example 2

A toner core body prepared as in Example 1 was subjected to a surfusing treatment for modifying the surface of the toner core so as to form a surface layer.

A toner core was prepared as in Example 1 by using the toner core body thus obtained, followed by forming multi-layered toner particles. Further, a toner was prepared by using the multi-layered toner particles.

The blocking resistance of the toner thus obtained was evaluated as in Example 1. Also, a developing agent was prepared as in Example 1 by using the toner thus obtained, and the fixation remaining rate of the developing agent was measured and evaluated. Further, the manufacturing cost was evaluated as in Example 1. Table 1 shows the results.

As shown in Table 1, the fixation remaining rate was found to be 85%. The blocking resistance was found to be satisfactory (cohesion lump was not recognized). Further, the manufacturing cost was low.

### Example 3

Added to 70 parts by weight of a toner core body, which had been subjected to a surfusing treatment as in Example 2, were 5 parts by weight of a copper phthalocyanine series cyan pigment, 4 parts by weight of polypropylene wax and 1 part by weight of a colorless metal complex CCA. The resultant mixture was subjected to a mechanofusion treatment so as to cover the toner core body with an intermediate layer containing the coloring agent, thereby obtaining a toner core.

A toner was obtained as in Example 1 by using the toner core thus obtained.

The fixation remaining rate, the blocking resistance and the manufacturing cost were measured and evaluated as in Example 1 by using the toner thus obtained. Table 1 shows the results.

### Example 4

An ordered mixture was formed by dry mixing 20 parts by weight of polyester fine particles having a glass transition point of 55° C. and an average particle diameter of 150 nm, which were used as a resin covering material, with 80 parts by weight of a toner core, which had been subjected to a surfusing treatment and a mechanofusion treatment as in Example 2. The ordered mixture thus obtained was subjected to a mechanofusion treatment and, then, to a surfusing treatment as in Example 1 so as to obtain multi-layered toner particles in which the toner core was covered with the polyester resin.

A toner was obtained as in Example 1 by using the multi-layered toner particles thus obtained.

The fixation remaining rate, the blocking resistance and the manufacturing cost were measured and evaluated as in Example 1 by using the toner thus obtained. Table 1 shows the results.

### Example 5

An ordered mixture was formed by dry mixing 20 parts by weight of acrylic resin fine particles having a glass transition point of 55° C. and an average particle diameter of 150 nm, which were used as a resin covering material, with 80 parts by weight of a toner core, which had been subjected to a surfusing treatment and a mechanofusion treatment as in Example 2. The ordered mixture thus obtained was subjected to a hybridization treatment by using a Hybridization System 1 type manufactured by Nara Kikai Seisakusho K.K. for 1 to 20 minutes with the peripheral speed of system set at 20 to 120 m/sec so as to obtain multi-layered toner particles in which the toner core was covered with the acrylic resin.

A toner was obtained as in Example 1 by using the multi-layered toner particles thus obtained.

The fixation remaining rate, the blocking resistance and the manufacturing cost were measured and evaluated as in Example 1 by using the toner thus obtained. Table 1 shows the results.

### Example 6

Added to 70 parts by weight of a toner body, which had been subjected to a surfusing treatment as in Example 2, were 5 parts by weight of a copper phthalocyanine series cyan pigment, 4 parts by weight of polypropylene wax, and 1 part by weight of a colorless metal complex CCA. The resultant mixture was subjected to a hybridization treatment so as to obtain a toner core, in which the toner core body was covered with an intermediate layer containing a coloring agent.

Multi-layered toner particles were obtained as in Example 5 by using the toner core thus obtained.

A toner was obtained as in Example 1 by using the multi-layered toner particles thus obtained.

The fixation remaining rate, the blocking resistance and the manufacturing cost were measured and evaluated as in Example 1 by using the toner thus obtained. Table 1 shows the results.

### Example 7

Prepared as a toner core body was a styrene acrylic resin having a glass transition point of 60° C., which had been obtained by a polymerization method.

A toner core was prepared as in Example 1 by using the toner core body thus obtained, followed by forming multi-layered toner particles and subsequently forming a toner by using the multi-layered toner particles thus obtained.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Example 8

A toner core body obtained as in Example 7 was subjected to a surfusing treatment so as to form a layer.

A toner core was prepared as in Example 1 by using the toner core body thus obtained, followed by forming multi-layered toner particles and subsequently forming a toner by using the multi-layered toner particles thus obtained.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Example 9

Added to 70 parts by weight of polyester resin having a glass transition point of 40° C. were 5 parts by weight of a copper phthalocyanine series cyan pigment, 4 parts by weight of polypropylene wax, and 1 part by weight of a colorless metal complex CCA. The resultant mixture was subjected to drying, pulverization and classification so as to obtain a toner core.

Multi-layered toner particles were obtained as in Example 1 by using the toner core thus obtained, followed by forming multi-layered toner particles and subsequently forming a toner by using the multi-layered toner particles.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Example 10

A toner core body obtained as in Example 9 was subjected to a surfusing treatment for modifying the surface of the toner core so as to form a surface layer.

A toner core was prepared as in Example 1 by using the toner core body thus obtained, followed by forming multi-layered toner particles and subsequently forming a toner by using the multi-layered toner particles thus obtained.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Example 11

A toner core was obtained as in Example 9, except that a styrene acrylic resin was used in place the polyester resin.

A toner core was prepared as in Example 1 by using the toner core body thus obtained, followed by forming multi-layered toner particles and subsequently forming a toner by using the multi-layered toner particles thus obtained.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Example 12

A toner core body obtained as in Example 11 was subjected to a surfusing treatment for modifying the surface of the toner core so as to form a surface layer.

A toner core was prepared as in Example 1 by using the toner core body thus obtained, followed by forming multi-layered toner particles and subsequently forming a toner by using the multi-layered toner particles thus obtained.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 1

A toner was obtained by mixing 1.0 part by weight of silica particles with 100 parts by weight of the toner core prepared in Example 9 by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 2

A toner was obtained by mixing 1.0 part by weight of silica particles with 100 parts by weight of the toner core prepared in Example 10 by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 3

A toner was obtained by mixing 1.0 part by weight of silica particles with 100 parts by weight of the toner core prepared in Example 11 by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 4

A toner was obtained by mixing 1.0 part by weight of silica particles with 100 parts by weight of the toner core prepared in Example 12 by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 5

Toner particles were prepared by a polymerization method by using as the raw materials 90 parts by weight of styrene acrylic binder resin having a glass transition point of 40° C., 5 parts by weight of copper phthalocyanine series cyan pigment, 4 parts by weight of polypropylene wax, and 1 part by weight of a colorless metal complex CCA.

A toner was obtained by mixing 1.0 part by weight of silica particles with 100 parts by weight of the toner particles thus obtained by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 6

A resin covering layer was formed by a polymerization method by using an acrylic resin material having a glass transition point of 55° C., with the toner particles obtained in Comparative Example 1 used as the toner core, so as to obtain multi-layered toner particles.

A toner was obtained by mixing 1.0 part by weight of silica particles with 100 parts by weight of the multi-layered toner particles thus obtained by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 7

Toner particles were prepared by melting and kneading a mixture containing 90 parts by weight of polyester resin having a glass transition point of 55° C., 5 parts by weight of copper phthalocyanine series cyan pigment, 4 parts by weight of polypropylene wax, and 1 part by weight of a colorless metal complex CCA, followed by drying and pulverizing the kneaded mixture and subsequently classifying the pulverized mixture.

A toner was obtained by mixing 1.0 part by weight of silica particles with 100 parts by weight of the toner particles thus obtained by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

### Comparative Example 8

Toner particles were obtained as in Comparative Example 7, except that a styrene acrylic resin having a glass transition point of 55° C. was used in place the polyester resin.

A toner was obtained by mixing 1.0 part by weight of silica particles with 100 parts by weight of the toner particles thus obtained by using a Henschel mixer.

The blocking resistance of the obtained toner was evaluated as in Example 1. Also, a developing agent was prepared as in Example 1 by using the obtained toner so as to measure and evaluate the fixation remaining rate of the developing agent.

Further, the manufacturing cost was evaluated as in Example 1.

Table 1 shows the results of the evaluation.

TABLE 1

| | | Fixation | | |
|---|---|---|---|---|
| | | remaining | Blocking | |
| | | rate | resistance | Cost |
| Examples | 1 | 85 | Good | Low |
| | 2 | 85 | Good | Low |
| | 3 | 85 | Good | Low |
| | 4 | 85 | Good | Low |
| | 5 | 85 | Good | Low |
| | 6 | 85 | Good | Low |
| | 7 | 80 | Good | Low |
| | 8 | 80 | Good | Low |
| | 9 | 85 | Good | Low |
| | 10 | 85 | Good | Low |
| | 11 | 80 | Good | Low |
| | 12 | 80 | Good | Low |
| Comparative | 1 | 85 | Poor | Low |
| Examples | 2 | 85 | Poor | Low |
| | 3 | 80 | Poor | Low |
| | 4 | 80 | Poor | Low |
| | 5 | 80 | Poor | High |
| | 6 | 80 | Good | High |
| | 7 | 60 | Good | Low |
| | 8 | 55 | Good | Low |

As apparent Examples 1 to 12 shown in Table 1, the developing agent of the present invention can be manufactured at a low manufacturing cost and is satisfactory in each of the fixing properties and the resistance to blocking.

Also, where a binder resin having a low glass transition point is used and a resin covering layer is not formed as in Comparative Examples 1 to 4, a cohesion lump is observed, leading to a poor resistance to the blocking. However, it is possible to obtain a toner satisfactory in the fixing properties and free from a cohesion lump so as to improve the resistance to the blocking by forming a resin covering layer by using a binder resin having a high glass transition point as in Examples 9 to 12.

Also, a cohesion lump is not observed in the toner using a binder resin having a high glass transition point. However, the fixing properties of the toner are rendered poor as apparent from Comparative Examples 7 and 8. However, where a resin covering layer containing a binder resin having a high glass transition point is formed on the surface of the toner core containing a binder resin having a low glass transition point, it is possible to obtain a toner satisfactory in the fixing properties and free from a cohesion lump so as to improve the resistance to the blocking as apparent from Examples 1 to 12.

It has also been found that the manufacturing cost is increased if the toner core is formed by a polymerization method, as apparent from Comparative Examples 5 and 6.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising multi-layered toner particle including a toner core containing a coloring agent and a binder resin, and a resin covering layer formed by a dry process to cover the toner core.

2. The developing agent according to claim 1, wherein said dry process is selected from the group consisting of a mechanical process, a thermal process, a mechanochemical process, and a complex process involving at least two of these processes.

3. The developing agent according to claim 1, wherein said dry process is selected from the group consisting of a mechanofusion process, a hybridization process and a surfusing process.

4. The developing agent according to claim 1, wherein said coloring agent is attached to the surface of a core body containing mainly a binder resin.

5. The developing agent according to claim 1, wherein said coloring agent is dispersed in said toner core.

6. The developing agent according to claim 1, wherein said toner core further contains a wax.

7. The developing agent according to claim 1, wherein said toner core is formed by a polymerization method or a pulverization method.

8. The developing agent according to claim 1, wherein said resin covering layer includes a plurality of layers formed by successively covering said toner core with at least two resin covering materials by a dry process.

9. The developing agent according to claim 8, wherein said resin covering layer is of a laminate structure including at least three layers.

10. The developing agent according to claim 1, wherein said resin covering layer further contains a wax.

11. The developing agent according to claim 1, wherein said resin covering layer further contains a coloring agent.

12. A method of manufacturing a developing agent, comprising obtaining multi-layered toner particle by forming a resin covering layer by a dry process to cover a toner core containing a coloring agent and a binder resin.

13. The method of manufacturing a developing agent according to claim 12, wherein said dry process is selected from the group consisting of a mechanical process, a thermal process, a mechanochemical process, and a complex process involving at least two of these processes.

14. The method of manufacturing a developing agent according to claim 12, wherein said dry process is selected from the group consisting of a mechanofusion process, a hybridization process and a surfusing process.

15. The method of manufacturing a developing agent according to claim 12, wherein said coloring agent is attached to the surface of a core body containing mainly a binder resin.

16. The method of manufacturing a developing agent according to claim 12, wherein said coloring agent is dispersed in said toner core.

17. The method of manufacturing a developing agent according to claim 12, wherein said toner core further contains a wax.

18. The method of manufacturing a developing agent according to claim 12, wherein said toner core is formed by a polymerization method or a pulverization method.

19. The method of manufacturing a developing agent according to claim 12, wherein said resin covering layer includes a plurality of layers formed by successively covering said toner core with at least two resin covering materials by a dry process.

20. The method of manufacturing a developing agent according to claim 19, wherein said resin covering layer is of a laminate structure including at least three layers.

21. The method of manufacturing a developing agent according to claim 12, wherein said resin covering layer further contains a wax.

22. The method of manufacturing a developing agent according to claim 12, wherein said resin covering layer further contains a coloring agent.
